(19) United States
(12) Patent Application Publication
(10) Pub. No.: US 2014/0312612 A1
(43) Pub. Date: Oct. 23, 2014

(54) END FITTING FOR FLEXIBLE PIPE

(71) Applicants: Alok Dhagat, Katy, TX (US); David Michael McCall, Richmond, TX (US)

(72) Inventors: Alok Dhagat, Katy, TX (US); David Michael McCall, Richmond, TX (US)

(73) Assignee: DEEPFLEX INC., Houston, TX (US)

(21) Appl. No.: 14/357,410

(22) PCT Filed: Nov. 16, 2011
(86) PCT No.: PCT/US2011/060963

§ 371 Date: Jul. 1, 2014

(51) Int. Cl. F16L 33/01; B23P 19/00; F16L 13/14

(52) U.S. Cl. CPC F16L 33/01; F16L 13/143; B23P 19/00
USPC 285/245; 29/890.144; 29/505; 29/506; 29/515

(57) ABSTRACT

The present disclosure relates to an end fitting and method to install the end fitting to a flexible pipe. The method includes disposing a shell mandrel at a free end of the flexible pipe external to a jacket of the flexible pipe and performing a cutback of layers of the flexible pipe to expose an internal pressure sheath of the flexible pipe. An armor layer of the flexible pipe is radially outward from an axial direction of the flexible pipe. At least one internal pressure containment transition component and at least one internal pressure sheath seal are installed on the exposed free end of the flexible pipe. The end fitting is assembled such that the at least one internal pressure containment transition component and at least one seal are assembled with non-radial fasteners having a backward facing direction.

### BACKGROUND OF THE DISCLOSURE

1. Field of the Disclosure

The present disclosure relates to end fittings for flexible pipe and methods to install the same.

2. Description of the Related Art

A flexible pipe, or flow line, may be utilized as a dynamic riser to couple a rigid flow line or another flexible pipe on a seabed to a floating vessel or buoy to convey production fluids such as oil, gas or oil/gas mixtures under pressure from an oil/gas well or platform to the vessel or buoy. An end fitting may be utilized to couple the flexible pipe at each end to an adjacent pipe or wellhead and the vessel or buoy. An end fitting may also be used on land-based operations to connect pipe to wellheads and/or other equipment used in oil/gas production.

When crude oil, gas, or other similar fluids are transported through pipes and/or risers in subsea environments, several challenges are presented with respect to designing the pipes and risers for transporting the fluids, and providing proper end fittings for same. For example, the pipes and risers must provide a fluid barrier while being resistant to internal and external pressure and tension loading, yet must be flexible and connectable to other equipment. The end fitting must provide a suitable transition between the flexible pipe body and a connector flange or hub such that the different pipe layers are terminated in the end fitting so as to transfer the loads between the flexible pipe and the connector. There must also be effective sealing components in the end fitting to prevent leakage of conveyed fluids to the environment. To this end, many designs of this type require sophisticated sealing, anchoring, and load transfer components between the pipe and its end fitting, which designs are expensive and require extensive amounts of labor to assemble.

### SUMMARY OF THE CLAIMED SUBJECT MATTER

In one aspect, the present disclosure relates to a method to install an end fitting to a flexible pipe. The method includes disposing a shell mandrel at a free end of the flexible pipe external to a jacket of the flexible pipe and performing a cutback of layers of the flexible pipe to expose an internal pressure sheath of the flexible pipe. An armor layer of the flexible pipe is flared radially outward from an axial direction of the flexible pipe. At least one internal pressure containment transition component and at least one internal pressure sheath seal are installed on the exposed free end of the flexible pipe. The end fitting is assembled such that the at least one internal pressure containment transition component and at least one seal are assembled with non-radial fasteners having a backward facing direction.

In another aspect, the present disclosure relates to an end fitting for a flexible pipe assembly. The end fitting includes one or more internal pressure containment transition components, one or more internal pressure sheath seals, a shell mandrel, and a plurality of fasteners configured to connect the elements of the end fitting. The elements of the end fitting are configured to be assembled such that non-radial fasteners of the plurality of fasteners have a backward facing direction.

In another aspect, the present disclosure relates to an end fitting for a flexible pipe assembly. The end fitting includes one or more means for internal pressure containment transition, one or more means for sealing an internal pressure sheath, a shell mandrel, and a plurality of means for connecting configured to connect the elements of the end fitting. The elements of the end fitting are configured to be assembled such that non-radial means for connecting of the plurality of means for connecting have a backward facing direction.

Other aspects and advantages of the invention will be apparent from the following description and the appended claims.

### BRIEF DESCRIPTION OF DRAWINGS

Features of the present disclosure will become more apparent from the following description in conjunction with the accompanying drawings.

FIG. 1A is an isometric view of a pipe structure in accordance with one or more embodiments of the present disclosure.

FIG. 1B is a cross-sectional view of a pipe structure in accordance with one or more embodiments of the present disclosure.

FIGS. 2 through 5 show multiple schematic cross-sectional views of pipe structures and end fittings in accordance with one or more embodiments of the present disclosure.

FIG. 6A shows a schematic cross-sectional view of an assembled pipe structure and end fitting in accordance with one or more embodiments of the present disclosure. FIG. 6B shows an end-on view of the assembled pipe structure and end fitting of FIG. 6A.

FIGS. 7 and 8 show flow charts of procedures to install an end fitting in accordance with one or more embodiments of the present disclosure.

### DETAILED DESCRIPTION

Embodiments of the present disclosure are explained below, referring to the attached figures. In embodiments described herein, numerous specific details are set forth in order to provide a more thorough understanding. However, it will be apparent to one of ordinary skill in the art that the claimed invention may be practiced without these specific details. In other instances, well-known features have not been described in detail to avoid obscuring the invention.

It should be understood that the following disclosure provides many different embodiments, or examples, for implementing different features of various embodiments. Specific examples of components and arrangements are described below to simplify the present disclosure. These are, however, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

Historically, during installation of end fittings on flexible pipe, structural damage may occur to elements of the flexible pipe due to a bend back of the tensile armor layers of the flexible pipe necessary to install components of the end fitting. Where the tensile armor layers of the pipe are bent back, stress concentrations and/or excess strains may result, causing structural deformities and/or damage (i.e., fiber breakage or matrix cracking in composite tensile armor layers and strain hardening in steel tensile armor layers that may result in lower fatigue resistance). This may occur in both steel armored flexible pipes and composite armored flexible pipe, such as fiber reinforced composite armored flexible pipe.

Accordingly, one or more embodiments of the present disclosure allow for minimizing the structural stresses and/or strains imposed on the tensile armor elements of the flexible pipe during installation of an end fitting, and also result in an end fitting that is shorter in length than other flexible pipe end fittings known in the art. Although embodiments discussed herein will be in reference to a composite armored flexible pipe, those skilled in the art will appreciate that the procedures and end fittings disclosed herein may be used with steel armored flexible pipe, or other pipe structures known to those having skill in the art.

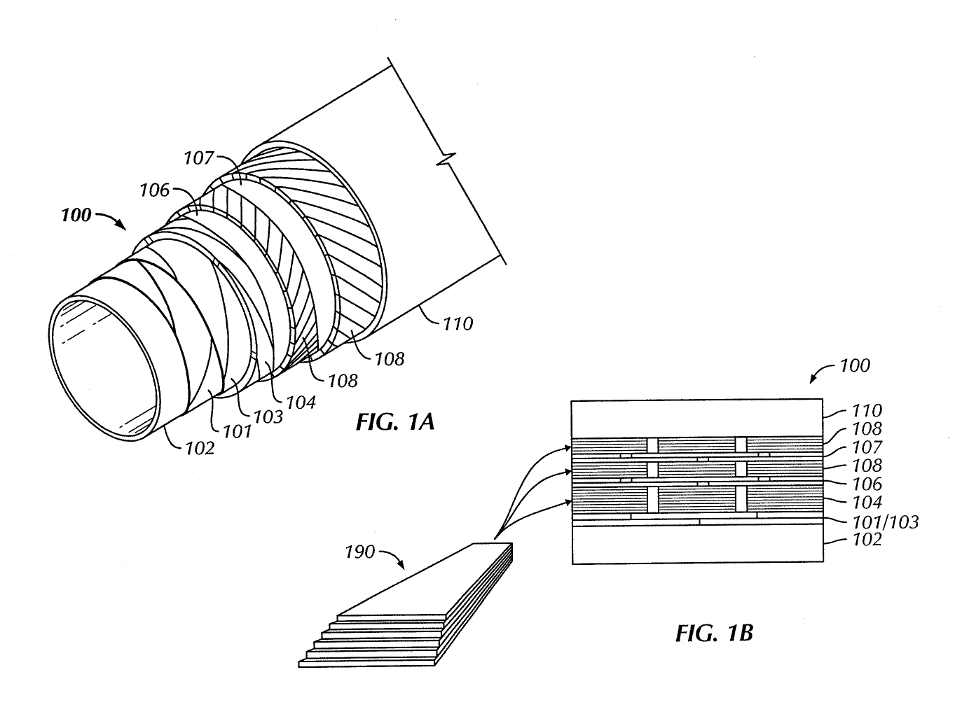

Referring initially to FIG. 1A, an isometric view of a spoolable pipe 100 is shown. An internal pressure sheath 102, such as a liner, may be wrapped with one or more armor layers and additional structural and/or functional layers. For example, one or more load bearing layers 108 composed of reinforcement stacks comprising stacks of laminates helically wrapped about the pipe 100, may be provided as structural layers of the pipe 100. As used herein, load bearing layers will be referred to as armor layers, however, those skilled in the art will appreciate that a load bearing layer may be any type of structural layer that provides structural support and/or pressure resistance to a flexible pipe. When more than one armor layer 108 is provided, the layers may have one or more orientations of wrapping. Further, one or more armor layers 104, composed of helically wrapped reinforcement stacks comprising stacks of laminates, may be wrapped at different, for example higher, lay-angles to form additional armor layers with different functional characteristics. Intermediate sheath and anti-wear layers 106 and 107, such as anti-wear layers, may be disposed between armor layers 104 and one or more armor layers 108 and one or more anti-extrusion layers 101 and 103 may be disposed between the inner most armor layer 104 and the internal pressure sheath 102. A jacket 110 may cover the armor layers and other elements of the pipe 100 to provide external protection. Although described herein with one or more intermediate sheath layers, those skilled in the art will appreciate that a flexible pipe may not have an intermediate sheath layer without departing from the scope of the present disclosure.

Referring now to FIG. 1B, a cross-sectional view of a composite armored spoolable pipe 100 is shown. An internal pressure sheath 102, such as a liner, may be wrapped with one or more armor layers and additional structural and/or functional layers, as described above. For example, armor layers 104 and one or more armor layers 108 may be provided as structural layers of the pipe 100. Armor layers 104 and 108 may be composed of stacks of laminates and/or tape 190. Anti-wear layers 106 and 107 may be disposed between armor layers 104 and 108 and/or between one or more armor layers 108. Further, one or more anti-extrusion layers 101 and 103 may be disposed between the inner most armor layer 104 and the internal pressure sheath 102. A jacket 110 may cover the armor layers and other elements of the pipe 100 to provide external protection.

Although FIGS. 1A and 1B depict pipe structures 100 of a spoolable pipe, these are merely for example only, and those skilled in the art will appreciate that a spoolable pipe may include additional and/or different layers, without departing from the scope of the present disclosure. For example, a spoolable pipe structure may include various combinations of internal pressure sheaths, liners, carcasses, hoop-strength or pressure armor layers, intermediate sheaths, anti-wear layers, lubricating layers, tensile armor layers, anti-extrusion layers, insulation layers, membranes, and/or any other layers as may be included in a spoolable and/or flexible pipe, without departing from the scope of the present disclosure.

Referring again to FIG. 1A, armor layers 104 and 108 may provide various structural protection and/or strength to flexible pipe 100. For example, the reinforcement stacks of armor layer 104 may be configured and oriented to form a hoop-strength armor layer and the reinforcement stacks of armor layers 108 may be configured and oriented to form tensile armor layers. Generally, as used herein, an armor layer may be a tensile armor layer, a hoop-strength armor layer, or other reinforcement and/or structural armor layer of a spoolable or flexible pipe and may be composed of one or more stacks of laminates and/or reinforcement tape, as discussed hereinafter.

The armor layers 104 and 108 may comprise helically wrapped stacks of laminated material. The stacks may be made of non-metallic fiber-reinforced tapes that may be laminated and bonded together as a single structural member. The individual layers of the stacks may include UD (unidirectional) tape and/or other structural and/or reinforced tape. Examples of this structure may be found, for example, in U.S. Pat. No. 6,491,779, issued on Dec. 12, 2002, entitled “Method of Forming a Composite Tubular Assembly,” U.S. Pat. No. 6,804,942, issued on Oct. 19, 2004, entitled “Composite Tubular Assembly and Method of Forming Same,” and U.S. Pat. No. 7,254,933, issued on Aug. 14, 2007, entitled “Anti-collapse System and Method of Manufacture,” all of which are hereby incorporated by reference in their entireties. Alternatively, if flexible pipe 100 represents a flexible steel pipe, armor layers 104 and 108 may be helically wrapped steel windings of steel wires. Examples of this structure may be found in ISO 13628-2/API 17J Specification for Unbonded Flexible Pipe, incorporated by reference in its entirety.

In former termination processes, the tensile armor layer 108 is bent back to accommodate installation of the end fitting. The bending back of the elements of tensile armor layer 108 may result in relatively high amounts of strain on the elements of the layers, thereby causing matrix cracking or fiber breakage in composite armor, or strain hardening, and/or other types of damage in steel and/or composite armor, all of which may reduce structural capacity or fatigue life of the tensile armor. In order to obtain access to the components of the end fitting, the outer structural layers of the flexible pipe must be bent back significantly from the terminal end of the flexible pipe. The bend back of the outer structural layer allows for access to the underlying layers for installing end fitting components during installation of the end fitting.

One or more embodiments of the present disclosure are directed to installation of an end fitting in order of components from a point along the length of the pipe towards a free end or terminal end of the flexible pipe. Further, one or more embodiments of the present disclosure are directed to installation of end fitting components in a configuration such that any connecting bolts of components of the end fitting are not facing towards the free end of the flexible pipe. For example, when using threaded bolts and/or screws, the treaded end of the bolts and/or screws are not facing towards the free end of the flexible pipe, i.e., facing away from the free end of the flexible pipe. As such, one or more embodiments of the present disclosure may minimize and/or eliminate reduction of structural capacity or fatigue life of the elements of the flexible pipe during installation of an end fitting. Because the direction of installation of elements of the end fitting are reversed, the tensile armor of the flexible pipe may not need to be bent back, but only may require a flaring radially outward from the terminal end of the flexible pipe. When flared, lower strains may be imposed on the flared elements, and fatigue and/or damage may be minimized and/or eliminated.

As used herein, the term “radially” is characterized by a direction extending in a generally radial (or perpendicular) direction to an axis of the pipe and “axially” is characterized as a direction extending along the axis of the pipe. However, it should be understood that items wrapped helically around the pipe may not be purely radially extended from the axis of the pipe during the end fitting installation process, but instead may be moved away in a hybrid direction that is both radial and helical with respect to the longitudinal axis of the pipe (axial direction). Therefore, for purposes of this disclosure, such radial and helical extension will be simply referred to as “radial.” Furthermore, for purposes of this disclosure “forward” will refer to the direction towards a terminal end of the flexible pipe in the axial direction and “backward” will refer to a direction away from a terminal end of the flexible pipe in the axial direction.

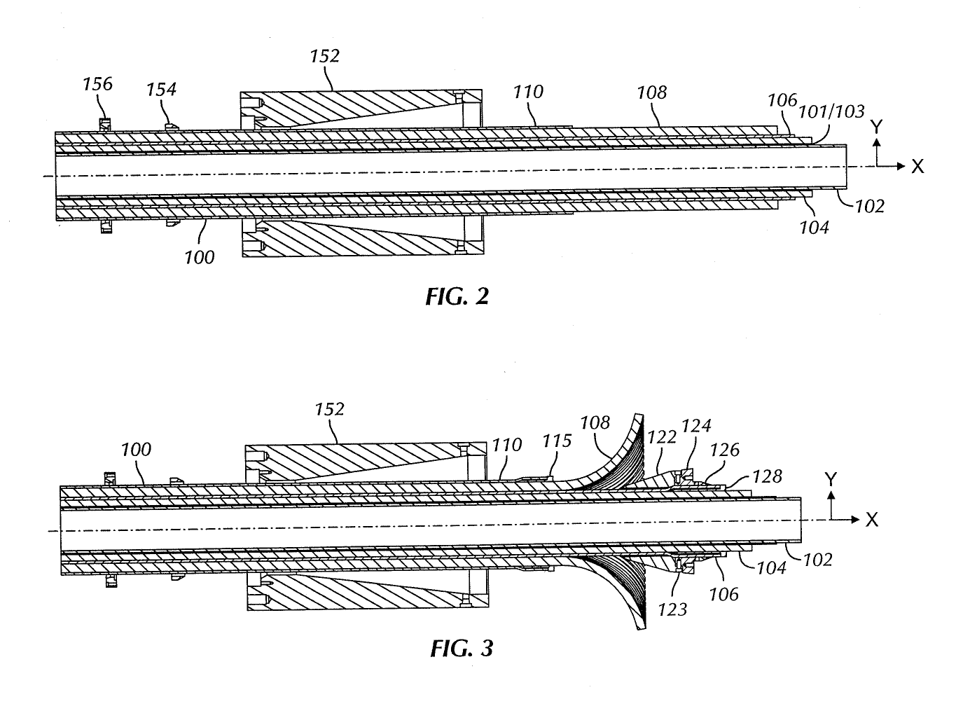

Now referring to FIGS. 2-6, schematic cross sectional views of a flexible pipe in various (progressive) stages of the installation of an end fitting assembly, in accordance with one or more embodiments of the present disclosure, are shown. In FIGS. 2-6, the X-axis designates an axial direction (longitudinal axis), and the arrow of the X-axis is in the forward direction (toward the free end or terminal end of the flexible pipe), and the Y-axis designates a radial direction relative to the X-axis. As used herein, the phrase “backward facing” is in the negative X-direction of FIGS. 2-6. Accordingly, the fasteners described herein are installed with an installation or facing direction in the negative X-direction of FIGS. 2-6.

Referring now to FIG. 2, a schematic cross sectional view of a flexible pipe 100 and components of a partial end fitting assembly are shown. As shown in FIG. 2, the end fitting components, in part, consist of a shell mandrel 152, an anchor 154, and a push ring 156 configured to drive and/or energize the anchor 154. Although described herein as an anchor 154, the anchor 154 may also provide sealing or other characteristics. As shown in FIG. 2, the shell mandrel 152, the anchor 154, and the push ring 156 may be installed on and/or exterior to an outer jacket 110 of the flexible pipe 100. The jacket 110 may provide a protective outer cover for other elements of the pipe, which may include a first armor layer 108, an intermediate sheath layer 106, a second armor layer 104, and a internal pressure sheath 102. One or more anti-extrusion layers 101 and 103 may be disposed between the liner 102 and the second armor layer 104. The internal pressure sheath 102 may be an extruded core. In some embodiments, a relatively flexible metal carcass (not shown) may be positioned inside the internal pressure sheath 102 to prevent collapse resistance of the flexible pipe assembly 100.

As described above, the armor layers may be formed from strips of flexible steel or stacks of composite material and may be tensile layers, hoop strength layers, burst layers, and/or other armor layers. The type of armor layer may be determined by the lay angle of the elements of the armor layer with respect to the X-axis.

As shown in FIG. 2, a staggered cut back of the layers of the flexible pipe 100 has been carried out. Accordingly, the jacket 110 has a cut back farthest from a free end or terminal end of the pipe 100. Forward of the cut back of the jacket 110, in sequence approaching the terminal end of the flexible pipe, are the cut backs of the first armor layer 108, the intermediate sheath layer 106, the second armor layer 104, and the internal pressure sheath 102. The anti-extrusion layers 101 and 103 may be cut back at the cut of the second armor layer 104.

Now, referring to FIG. 3, additional components of an end fitting assembly are shown. As shown, an armor layer 108 is flared radially outward from an axial direction of the pipe 100 (the X-axis) such that minimal bend back of the stacks or wires comprising the armor layer 108 occurs. Moreover, to support the jacket 110 of the flexible pipe 100, a jacket support ring 115 may be installed between the jacket 110 and the armor layer 108. The jacket support ring 115 may support the jacket 110 while the armor layer 108 is flared and/or may support the jacket 110 when the shell mandrel 152 is engaged with a flange assembly, as discussed herein. Moreover, the jacket support ring 115 may be configured to support the jacket 110 to obtain a required squeeze to enable anchoring and sealing of the jacket layer 110 when energizing and/or engaging anchor 154 and push ring 156.

As further shown in FIG. 3, internal pressure containment transition components may be installed beneath the flared armed layer 108. The internal pressure containment transition components may include an aft cone 122, a push plate 124, a membrane seal 126, and a membrane support ring 128. The aft cone 122 and the push plate 124 may slide over an intermediate sheath layer 106 beneath the radially flared armor layer 108. The aft cone 122 and the push plate may be secured together by fasteners 123, such as bolts, screws, or other connectors and/or securing means known in the art. As shown, fasteners 123 are disposed facing in a radial direction. The membrane support ring 128 may slide beneath the intermediate sheath layer 106 and on top of a second armor layer 104.

The membrane seal 126 is shown in FIG. 3 as having a wedge or triangular shape, with the narrow end facing toward the terminal end of the flexible pipe.

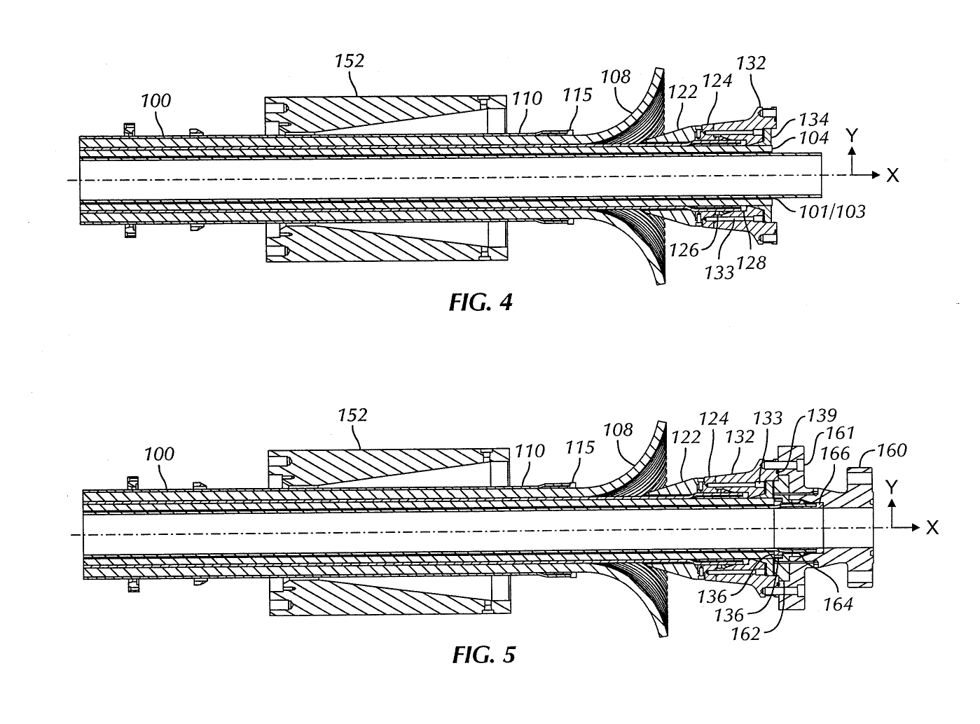

Now with reference to FIG. 4, an end fitting partial assembly, including a shell mandrel 152 and internal pressure containment transition components, is shown installed on a flexible pipe 100. As shown in FIG. 4, the armor layer 108 is still flared when an inner cone 132 of the internal pressure containment transition components is installed. The inner cone 132 may be configured to cover membrane seal 126 and contact a surface of the push plate 124.

The membrane seal 126 may be energized by securing the inner cone 132 to the push plate 124 by fasteners 133, such as bolts, screws, or other connectors and/or securing means known in the art. Although shown with bolts or screws 133, those skilled in the art will appreciate that other securing means may be used to join the inner cone 132 with the push plate 124 and/or energize the membrane seal 126. The fasteners 133 are installed such that the fasteners 133 face away-from the terminal end of the flexible pipe, in a backward facing orientation, facing in the negative X direction. The fasteners 133 may have threading configured such that the fastener is threaded in a negative X direction or in a backward facing orientation.

The inner cone 132 may be configured to house a pressure armor layer clamp 134. The pressure armor layer clamp 134 may hold a pressure armor layer 104 and anti-extrusion layers 101 and 103 within the internal pressure containment transition components and may be installed radially external to the armor layer 104.

Now referring to FIG. 5, the internal pressure containment transition components of an end fitting assembly described above may be connected with a flange assembly 160. The flange assembly 160 may be secured to the inner cone 132 by fasteners 161, such as bolts, screws, or other connectors and/or securing means known in the art. Similar to the fasteners 133, the fasteners 161 may be installed with a backward facing orientation. The flange assembly 160 may be positioned forward of the free end or terminal end of the pipe. A face seal 139 may be disposed between surfaces of the inner cone 132 and the flange assembly 160, thereby forming a fluid seal between the inner cone 132 and the flange assembly 160 when energized. The flange assembly 160 may provide a fluid seal at the free end or terminal end of the pipe and may provide a connecting end to connect with oil/gas production equipment.

A ring assembly 136 may be installed forward of and abutting the end of the armor layer 104 and may be positioned between components of the flange assembly 160 and the armor layer 104. The ring assembly 136 may be installed radially external to the internal pressure sheath 102. As such, the ring assembly 136 may be configured to cover and/or support a portion of the internal pressure sheath 102 that is not in contact with a portion of the flange assembly 160 and also not covered by a portion of the armor layer 104.

Prior to installation of the flange assembly 160, a liner support ring 166 may be positioned underneath and interior to the internal pressure sheath 102. A push ring 162 and a seal 164 may be installed on the internal pressure sheath 102. The flange assembly 160 may be installed on the free end of the flexible pipe and secured to the inner cone 132 by backward facing fasteners 161, such as bolts, screws, and/or other means. During this installation the flange assembly to the inner cone 132 may drive the push ring 162 against seal 164, thereby energizing the seal 164.

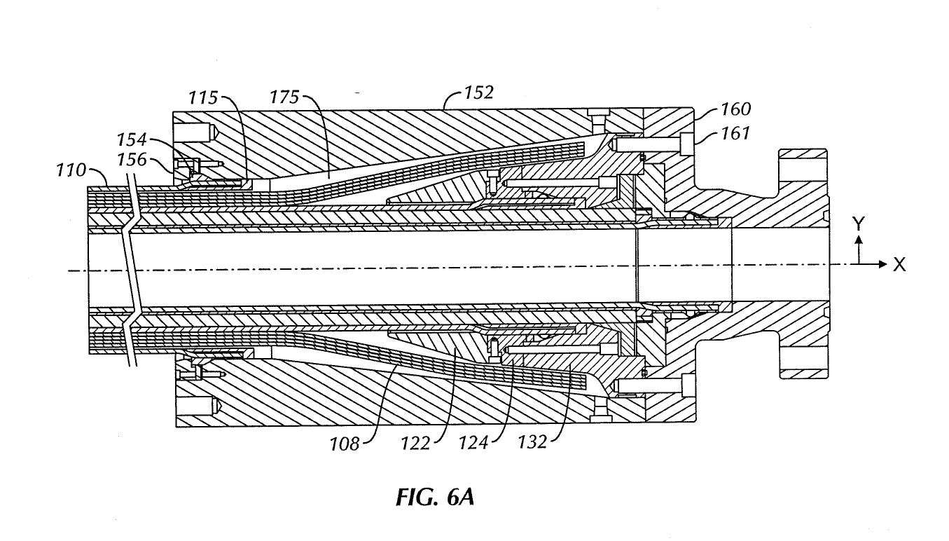

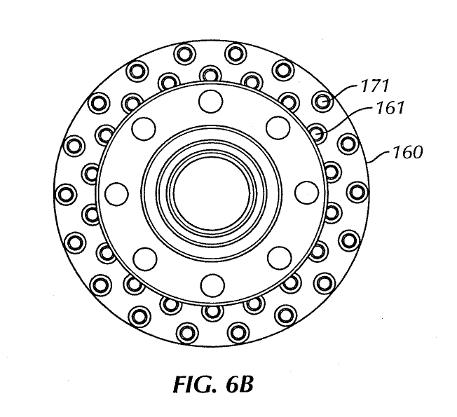

Now referring to FIG. 6A, a complete end fitting assembly 150 is shown installed on a free end or terminal end of a flexible pipe. The end fitting assembly may include a shell mandrel 152 external to a jacket 110 of the pipe and a flange assembly 160. Internal to the shell mandrel 152 and the flange assembly 160, internal pressure containment transition components may be disposed about and in relation to the interior layers of the flexible pipe. The flange assembly 160 may be installed terminal to the internal pressure containment transition components on the free end of the pipe. The shell mandrel 152, the flange assembly 160, and the internal pressure containment transition components of the end fitting assembly may be secured together to form the end fitting assembly.

When the end fitting is assembled with the shell mandrel 152, the flange assembly 160, and the internal pressure containment transition components, the flared armor layers 108 may be released to contact the external surfaces of the internal pressure containment transition components, as shown in FIG. 6A. The shell mandrel 152 may then be secured to the flange 160 using backward facing fasteners 171, such as bolts, screws, and/or other means, as shown in FIGS. 6A and 6B. The anchor 154 may then be engaged between a push ring 156 and the jacket 110. The flange assembly 160 may provide a connector for the end fitting such as a flange or hub, so that other tools, elements, and/or fluid conduits may be connected to the flexible pipe at the free end of end fitting. When assembled, the end fitting may have free volume 175 or voids between components of the end fitting and the flexible pipe. The free volume 175 may be filled with a thermoset resin or thermoplastic potting system.

As described herein, the end fitting components may include an aft cone, an inner cone, push plates, seals, rings, and fasteners. However, although described with a limited number of components, those skilled in the art will appreciate that the end fitting may include any number of components and/or other elements not described herein without departing from the scope of the present disclosure.

As shown in FIGS. 2-6, the fasteners of the internal pressure containment transition components may be installed such that they have a radial facing (123) or a backward facing orientation (133, 161, 171). However, those skilled in the art will appreciate that the fasteners may have slightly skewed orientations, having radial and backward facing components, without departing from the scope of the present disclosure. It should be noted that the only fasteners with a forward facing direction may be those connecting push ring (156) and the shell mandrel (152). In particular, none of the fasteners of the internal pressure containment transition components have a direction that is facing towards the free end of the pipe. Accordingly, the non-radial fasteners of the internal pressure containment transition components are configured to have, at least, a direction component that is facing backward or away from the free end of the flexible pipe.

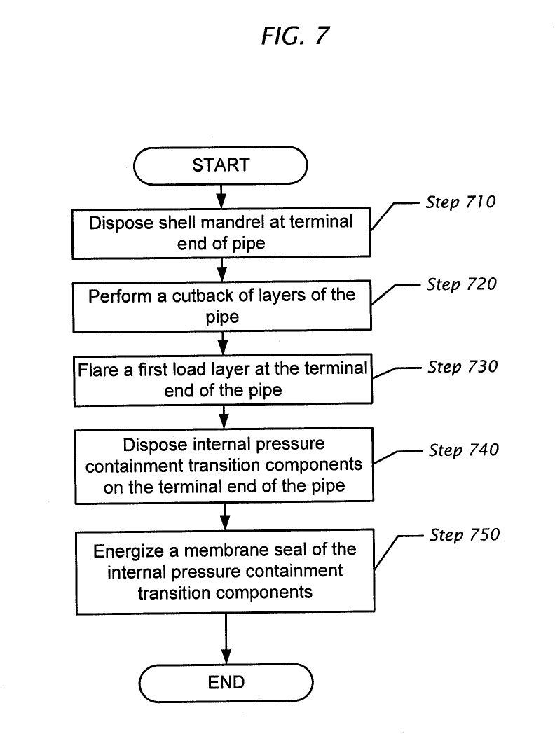

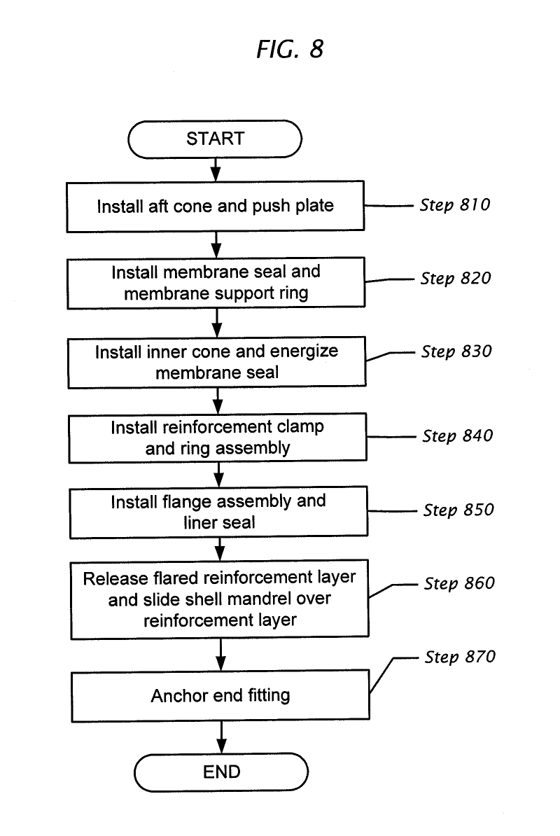

Referring now to FIG. 7, a flow chart of an installation process in accordance with one or more embodiments of the present disclosure is shown. At step 710, prior to installing the internal components of the end fitting, an external element of the end fitting, such as a shell mandrel (e.g., 152 of FIGS. 2-6), may be installed on an external jacket (e.g., 110 of FIGS. 2-6) of the flexible pipe (e.g., 100 of FIGS. 2-6). In addition to the shell mandrel, an anchor and a push ring may also be disposed with the shell mandrel on the jacket (e.g., 154 and 156 of FIGS. 2-6).

Next, at step 720, a cutback of the layers (e.g., 102, 104, 106, 108, and 110 of FIGS. 2-6) of the flexible pipe may be performed. When cutting back the layers of the flexible pipe, a staggered and/or stepped configuration may be preferred in order to properly install and seal the end fitting to the end of the flexible pipe. Accordingly, the different layers of the flexible pipe may be cut at different locations with respect to a free end or terminal end of the flexible pipe. For example, at step 720, the outer jacket (e.g., 110 of FIGS. 2-6) of the flexible pipe may be cut at a first location, farthest from the free end or terminal end of the flexible pipe with respect to all other cuts. The next cut may be of a first armor layer or a load bearing layer (e.g., 108 of FIGS. 2-6), where the cut of the first armor layer may be at a second location, closer to the free end or terminal end of the flexible pipe than the first location. Subsequent layers, such as an intermediate sheath layer (e.g., 106 of FIG. 2), a second armor layer (e.g., 104 of FIG. 2), and an internal pressure sheath (e.g., 102 of FIG. 2) may be cut at third, fourth, and fifth locations, with each location closer to the free end or terminal end of the flexible pipe than the previous cut.

Although described herein as a sequence of cuts occurring at a single time, within the installation process, those skilled in the art will appreciate that the cutback process at step 720 may occur throughout the installation process, with cutting of particular layers only occurring when necessary. Further, although described herein with the locations of the cuts each occurring at a different location, those skilled in the art will appreciate that some adjacent layers of the flexible pipe may be cut at a single location relative to the free end or terminal end of the flexible pipe.

Next, at step 730, the first armor layer, or load bearing layer, may be flared outward from the terminal end of the flexible pipe. The flaring process may involve spreading the individual elements of the armor layer, hereinafter referred to as stacks or wires, radially with respect to the axial direction (i.e., X-axis of FIGS. 2-6) of the flexible pipe such that the flared stacks or wires appear to be bell-shaped with the open end of the bell occurring at or toward the free end or terminal end of the pipe. The flaring width, or radial amount of flaring, is only necessary to be large enough to place the internal elements of the end fitting beneath the flare, as no access to the end of the end fitting farthest from the terminal end of the flexible pipe is necessary for assembling the end fitting. As such, minimal flaring and, therefore, minimal strains and/or forces may be imparted to the flared stacks or wires.

At step 730, prior to flaring, in order to support the jacket when the armor layer is flared, a jacket support ring (e.g., 115 of FIGS. 2-6) may be installed between the layer to be flared and the external jacket. Once flared, the stacks may be held in the flared position by string, wire, and/or any other method, during the installation of the end fitting.

Next, at step 740, internal elements of the end fitting may be installed (e.g., 122, 124, and 132 of FIGS. 2-6). The internal elements may form internal pressure containment transition components of the end fitting, and may further include one or more seals and/or ring assemblies and joining elements, such as bolts, screws, etc. The sequence and direction of assembly of the end fitting allows for the flaring of the armor layer to provide sufficient access to install all elements of the end fitting without imposing excess strains and/or forces on elements of the flexible pipe.

At step 750, once the internal elements of the end fitting have been installed on the terminal end of the flexible pipe, the membrane seal within the internal pressure containment transition components may be energized. To energize the membrane seal, an element of the internal pressure containment transition components may be pulled toward the free end or terminal end of the flexible pipe, or, alternatively, an element of the internal pressure containment transition components may be pushed and/or forced in a direction away from the free end of the flexible pipe, towards the push plate. For example, a push plate of the internal pressure containment transition components (e.g., 124 of FIGS. 2-6) may be used to energize the membrane seal by pulling the push plate toward the terminal end of the flexible pipe. The sheaths, as used herein may generally refer to an internal pressure sheath, a liner, an intermediate sheath, an anti-wear layer, an anti-extrusion layer, or other layer of a flexible pipe and may be an element of the flexible pipe disposed between other structural elements of the flexible pipe.

When the membrane seal is energized, a portion of the membrane seal may engage with the membrane, thereby providing a fluid seal between the end fitting and the membrane. In one or more embodiments of the present disclosure, the membrane seal may be a wedge shape and/or triangular in cross-section, as discussed above. When energizing the membrane seal at step 750, the push plate or other element may be pulled toward the free end or terminal end of the flexible pipe (forward), or another element may be pushed away from the free end or terminal end of the flexible pipe toward the push plate. As the membrane seal is pulled against the push plate, the membrane seal may compress a surface of the membrane, thereby forming a fluid seal.

Now, with reference to FIG. 8, a flow chart of an installation process in accordance with one or more embodiments of the present disclosure is shown. The end fitting components may include an aft cone (e.g., 122 of FIGS. 2-6), a push plate (e.g., 124 of FIGS. 2-6), an inner cone (e.g., 132 of FIGS. 2-6), and various other elements and components as described above. The internal pressure containment transition components may be interior components of the end fitting and a flange assembly (e.g., 160 of FIGS. 2-6) may be configured to attach to the internal pressure containment transition components. Although described herein with the listed elements, those skilled in the art will appreciate that an end fitting may contain more or fewer elements and/or different elements than those described herein without departing from the scope of the present disclosure.

The procedure described in FIG. 8 is conducted, at least initially, with at least one armor layer of the flexible pipe flared. As such, steps 710, 720, and 730 of FIG. 7 may be carried out prior to the start of the procedure of FIG. 8.

At step 810, after the armor layer of the flexible pipe is flared, an aft cone and a push plate may be disposed external to an intermediate sheath layer beneath the flared armor layer. The intermediate sheath layer is disposed between two armor layers of the flexible pipe. The aft cone may be installed first, followed by the push plate, with the two elements axially adjacent to and contacting each other. The aft cone and the push plate may be secured together, for example, by bolts, pins, and/or other means known in the art. Further, the two elements may be secured together prior to installation onto the flexible pipe or may be secured together after installation onto the flexible pipe. Moreover, those skilled in the art will appreciate that the two elements need not be secured together during the installation process of the end fitting.

At step 820, a membrane seal and a membrane support ring may then be installed axially forward of the push plate. The membrane support ring may be disposed radially beneath the first membrane, and the membrane seal may be disposed radially external to an intermediate sheath layer between two armor layers, such that the intermediate sheath layer is disposed between the membrane support ring and the membrane seal. The membrane support ring may provide rigidity and/or support to the intermediate sheath layer at the time of energizing of the membrane seal. Furthermore, the membrane support ring may prevent the membrane seal from excessive inward deformation of the intermediate sheath layer thereby preventing damage to a layer beneath the intermediate sheath layer. Accordingly, the membrane support ring may also provide a protective barrier for the layer radially beneath the membrane support ring.

Next, at step 830, an inner cone of the internal pressure containment transition components may be installed axially forward of the membrane seal, and at least a portion of the inner cone may contact a surface and/or a portion of the push plate. The inner cone and the push plate may be secured together to energize the membrane seal. As such, the membrane seal may be energized during step 830.

Next, at step 840, a pressure armor clamp and/or a ring assembly may be disposed radially within the inner cone. A sleeve may be disposed radially beneath an internal pressure sheath of the flexible pipe. The sleeve may be installed prior to installation of the ring assembly.

The pressure armor clamp may be disposed within the inner cone and may contact a surface of an inner armor layer, hereinafter referred to as a pressure armor layer. Further, the ring assembly may be disposed within the inner cone and may contact a surface of an internal pressure sheath of the flexible pipe. The ring assembly may contact a terminal end of the pressure armor layer such that the ring assembly may be axially forward of and adjacent to an end of the pressure armor layer. Next, at step 850, a flange assembly may be installed axially forward of the inner cone, the ring assembly, and the armor layer clamp. The flange assembly may be secured to the inner cone and/or the internal pressure containment transition components of the end fitting. When installed, the flange assembly may be in contact with a surface of the inner cone. A face seal may be disposed between a forward-facing surface of the inner cone and a backward-facing surface of the flange assembly. When energized, the face seal may form a fluid seal between the inner cone and the flange assembly. Further, the flange assembly may be configured to connect with oil/gas production equipment, enabling a flexible pipe to be connected to the oil/gas production equipment.

At step 860, after the flange assembly is secured to the internal pressure containment transition components of the end fitting, the stacks or wires of the armor layer that were flared may be released and the shell mandrel may be secured to the flange assembly. When the shell mandrel is slid forward, the shell mandrel may cover the stacks or wires of the armor layer that were flared. The layers of the armor layer that were flared may be disposed and/or wedged between the internal pressure containment transition components and the shell mandrel of the end fitting. Accordingly, the external armor layer may be covered by the shell mandrel.

Finally, at step 870, the armor layers and other layers of the flexible pipe may be secured and/or anchored to the end fitting. The anchoring may occur by filling the volume 175, as shown in FIG. 6, between the shell and flange of the end fitting, and any voids therein, with a thermoset resin or thermoplastic potting system. After the resin system is in place, the potting may be cured, thereby forming an anchored and sealed end fitting on the terminal end of a flexible pipe.

Advantageously, an end fitting and methods in accordance with one or more embodiments of the present disclosure may allow for simple installation of an end fitting onto a terminal end of a flexible pipe. The end fitting, in accordance with one or more embodiments of the present disclosure may allow for fasteners, such as bolts, screws, or other connection means to be installed backward facing, such that the internal pressure sheath seal and intermediate sheath seal may be energized. Forward facing bolts as in the prior art require clearance for bolts between the flared or bent back armor layers and the aft cone or internal pressure containment components. Thus, the end fitting can be shorter with backward facing bolts, since this additional clearance is not required.

Further, an end fitting and methods in accordance with one or more embodiments of the present disclosure may allow for minimized and/or eliminated strains imposed on the armor layers of the flexible pipe during end fitting installation. Advantageously, the end fitting and method may provide for flaring of the tensile armor layers. Accordingly, minimal bend back and/or severe strains need be imposed on the armor layers, thereby minimizing potential damage to the tensile armor layers during end fitting installation.

While the disclosure has been presented with respect to a limited number of embodiments, those skilled in the art, having benefit of this disclosure, will appreciate that other embodiments may be devised which do not depart from the scope of the present disclosure. Accordingly, the scope of the invention should be limited only by the attached claims.

What is claimed is:

1. A method to install an end fitting to a flexible pipe, the method comprising:
disposing a shell mandrel at a free end of the flexible pipe external to a jacket of the flexible pipe;
performing a cutback of layers of the flexible pipe to expose an internal pressure sheath of the flexible pipe;
flaring an armor layer of the flexible pipe radially outward from an axial direction of the flexible pipe;
installing at least one internal pressure containment transition component and at least one internal pressure sheath seal on the exposed free end of the flexible pipe; and
assembling the at least one internal pressure containment transition component and the at least one internal pressure sheath seal with non-radial fasteners having a backward facing direction.

2. The method of claim 1, wherein the performing the cutback of layers of the flexible pipe exposes an intermediate sheath, the method further comprising:
installing at least one intermediate sheath seal on the exposed free end of the flexible pipe with non-radial fasteners having a backward facing direction.

3. The method of claim 1, wherein the assembling the internal pressure containment transition components and the seals is done without using securing means that are facing substantially towards the free end of the flexible pipe.

4. The method of claim 1, wherein performing the cutback comprises:
cutting a jacket of the flexible pipe at a first location; and
cutting a first armor layer at a second location, wherein the second location is closer to the free end of the flexible pipe than the first location; and
cutting a second armor layer of the flexible pipe at a third location, wherein the third location is closer to the terminal end of the flexible pipe than the second location.

5. The method of claim 4, wherein performing the cutback further comprises:
cutting an intermediate sheath disposed between the first armor layer and the second armor layer at a position between the second location and the third location.

6. The method of claim 1, wherein the internal pressure sheath comprises a liner of a flexible pipe.

7. The method of claim 2, further comprising disposing a membrane support ring beneath the intermediate sheath prior to energizing the one or more intermediate sheath seals.

8. The method of claim 1, wherein the one or more internal pressure containment transition components comprise an aft cone, a push plate, and an inner cone.

9. The method of claim 1, further comprising:
installing a flange assembly on the free end of the flexible pipe terminal to the one or more internal pressure containment transition components.

10. The method of claim 9, further comprising securing the shell mandrel to the flange assembly at the free end of the flexible pipe.

11. The method of claim 1, wherein the armor layer comprises at least one of steel wires or a reinforcement stack.

12. The method of claim 1, wherein when flaring the armor layer elements of the armor layer, the armor layer elements are not bent back with respect to the free end of the flexible pipe.

13. An end fitting for a flexible pipe assembly, the end fitting comprising:
one or more internal pressure containment transition components;
one or more internal pressure sheath seals;
a shell mandrel; and
a plurality of fasteners configured to connect the elements of the end fitting,
wherein the elements of the end fitting are configured to be assembled such that the non-radial fasteners of the plurality of fasteners for assembling the internal pressure containment components and internal pressure sheath seals have a backward facing direction.

14. The end fitting of claim 13 further comprising one or more intermediate sheath seals, wherein the non-radial fasteners of the plurality of fasteners for energizing the intermediate sheath seal have a backward facing direction.

15. An end fitting for a flexible pipe assembly, the end fitting comprising:
one or more means for internal pressure containment transition;
one or more means for sealing an internal pressure sheath;
a shell mandrel; and
a plurality of means for connecting configured to connect the elements of the end fitting,
wherein the elements of the end fitting are configured to be assembled such that non-radial means for connecting of the plurality of means for connecting have a backward facing direction.

16. The end fitting of claim 15, further comprising one or more means to seal an intermediate sheath.

17. The end fitting of claim 15, further comprising:
a means for connecting to fluid production equipment to be connected to the one or more means for internal pressure containment transition with at least one of the plurality of means for connecting.
